(19) United States
(12) Patent Application Publication
(10) Pub. No.: US 2025/0063969 A1
(43) Pub. Date: Feb. 27, 2025

(54) SHANK ASSEMBLY FOR AN AGRICULTURAL IMPLEMENT

(71) Applicant: CNH Industrial America LLC, New Holland, PA (US)

(72) Inventors: William E. Preller, Congerville, IL (US); Brian Michael Craig, Congerville, IL (US); Austin Joseph Lewandowski, Congerville, IL (US); Jeffry Scott Huber, Eureka, IL (US)

(21) Appl. No.: 18/784,237

(22) Filed: Jul. 25, 2024

Related U.S. Application Data
(60) Provisional application No. 63/578,755, filed on Aug. 25, 2023.

(51) Int. Cl. A01B 35/22; A01B 35/26

(52) U.S. Cl. CPC A01B 35/225; A01B 35/26

(57) ABSTRACT

A shank assembly for an agricultural implement includes a ground-engaging shank having a shank body. Furthermore, the shank assembly includes a sleeve having a forward wall, an intermediate wall positioned aft of and spaced apart from the forward wall, and an aft wall positioned aft of and spaced apart from the intermediate wall. Additionally, the sleeve includes a first side wall coupled to the forward, intermediate, and aft walls on a first side of the sleeve and a second side wall coupled to the forward, intermediate, and aft walls on a second side of the sleeve. Moreover, the forward wall, the intermediate wall, the first side wall, and the second side wall collectively define a forward passage through which the shank body extends. In addition, the intermediate wall, the aft wall, the first side wall, and the second side wall collectively define an aft passage.

### CROSS-REFERENCE TO RELATED APPLICATIONS

This application is a continuation/divisional of and claims the right of priority to U.S. Provisional Patent Application No. 63/578,755, filed on Aug. 25, 2023, the disclosure of which is hereby incorporated by reference herein in its entirety for all purposes.

### FIELD OF THE INVENTION

The present disclosure generally relates to agricultural implements, such as strip tillage implements, and, more particularly, to a shank assembly for an agricultural implement.

### BACKGROUND OF THE INVENTION

Many agricultural implements include row units for processing narrow strips of soil during the performance of an agricultural operation. For instance, planters include planter row units for opening furrows along narrow strips of soil, depositing seeds within the furrows, and then subsequently closing the furrows. Similarly, strip-tillage implements include strip tillage row units for tilling narrow strips of soil to prepare the soil for subsequent planting.

In many instances, each row unit may include a shank assembly configured to be moved through the soil within the field as the row unit travels across the field. For example, the shank assembly of a strip tillage implement is configured to break up the soil along the lateral width of the row being formed by the row unit. Movement of the shank assembly through the soil generates friction between the shank assembly and the soil. Such friction, in turn, causes the shank assembly to wear out quickly, thereby necessitating frequent replacement.

Accordingly, an improved shank assembly for an agricultural implement would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a shank assembly for an agricultural implement. The shank assembly includes a ground-engaging shank having a shank body. Furthermore, the shank assembly includes a sleeve configured to protect the shank body. The sleeve, in turn, includes a forward wall, an intermediate wall positioned aft of and spaced apart from the forward wall in a longitudinal direction, and an aft wall positioned aft of and spaced apart from the intermediate wall in the longitudinal direction. Additionally, the sleeve includes a first side wall coupled to the forward wall, the intermediate wall, and the aft wall on a first side of the sleeve and a second side wall coupled to the forward wall, the intermediate wall, and the aft wall on a second side of the sleeve. Moreover, the forward wall, the intermediate wall, the first side wall, and the second side wall collectively define a forward passage through which the shank body extends. In addition, the intermediate wall, the aft wall, the first side wall, and the second side wall collectively define an aft passage.

In another aspect, the present subject matter is directed to a sleeve for agricultural implement shanks. The sleeve includes a forward wall extending in a lateral direction from a first side of the sleeve to a second side of the sleeve and an intermediate wall extending in the lateral direction from the first side to the second side, with the intermediate wall positioned aft of and spaced apart from the forward wall in a longitudinal direction extending perpendicular to the lateral direction. Furthermore, the sleeve includes an aft wall extending in the lateral direction from the first side to the second side, with the aft wall positioned aft of and spaced apart from the intermediate wall in the longitudinal direction. Additionally, the sleeve includes a first side wall extending in the longitudinal direction from a forward end of the sleeve to an aft end of the sleeve, with the first side wall coupled to the forward wall, the intermediate wall, and the aft wall on the first side. Moreover, the sleeve includes a second side wall extending in the longitudinal direction from the forward end to the aft end, with the second side wall coupled to the forward wall, the intermediate wall, and the aft wall on the second side. In addition, the forward wall, the intermediate wall, the first side wall, and the second side wall collectively define a forward passage configured to receive a ground-engaging shank of an agricultural implement. Furthermore, the intermediate wall, the aft wall, the first side wall, and the second side wall collectively define an aft passage configured to partially receive a dry agricultural product dispensing device of the agricultural implement.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter;

FIG. 2 illustrates a side view of one embodiment of a row unit suitable for use with the implement shown in FIG. 1 in accordance with aspects of the present subject matter;

FIG. 3 illustrates a side view of one embodiment of a shank assembly suitable for use with the implement shown in FIG. 1 and the row unit shown in FIG. 2 in accordance with aspects of the present subject matter;

FIG. 4 illustrates a front perspective view of one embodiment of a sleeve of the shank assembly shown in FIG. 3 in accordance with aspects of the present subject matter;

FIG. 5 illustrates a side view of the sleeve shown in FIG. 4 in accordance with aspects of the present subject matter;

FIG. 6 illustrates a rear perspective view of the sleeve shown in FIGS. 4 and 5 in accordance with aspects of the present subject matter;

FIG. 7 illustrates a partial side view of the shank assembly shown in FIG. 3 in accordance with aspects of the present subject matter, particularly illustrating the shank assembly with a forward wall, a first side wall, and a second side wall of the sleeve removed for clarity;

FIG. 8 illustrates a partial perspective view of the shank assembly shown in FIGS. 3 and 7 in accordance with aspects of the present subject matter;

FIG. 9 illustrates a top perspective view of the sleeve shown in FIGS. 4-6 in accordance with aspects of the present subject matter;

FIG. 10 illustrates a side view of the shank assembly shown in FIGS. 3, 7, and 8 in accordance with aspects of the present subject matter, particularly illustrating the shank assembly with all of its components except for a tube, an intermediate wall of the sleeve, a isolator coupling the to the intermediate wall, and a tab removed for clarity; and

FIG. 11 illustrates a partial sectional side view of a dry agricultural product dispensing device of the shank assembly shown in FIGS. 3, 7, 8, and 10 in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to a shank assembly for an agricultural implement, such as a strip tillage implement having a plurality of row units. Specifically, in several embodiments, the shank assembly includes a ground-engaging shank configured to be moved through the soil as the agricultural implement travels across the field (e.g., to perform a strip tillage operation thereon). In this respect, the shank assembly may break up the soil along a lateral width of the row or strip being tilled by the row unit on which the ground-engaging shank is mounted. The ground-engaging shank, in turn, includes a shank body forming the main structural component of the shank assembly. Additionally, in some embodiments, the ground-engaging shank may include other components, such as a shin positioned on a forward end of the shank body.

Furthermore, the shank assembly includes a sleeve configured to protect the shank body. More specifically, the sleeve includes a forward wall, an intermediate wall positioned aft of and spaced apart from the forward wall, and an aft wall positioned aft of and spaced apart from the intermediate wall. Furthermore, the sleeve includes a first side wall coupled to the forward wall, the intermediate wall, and the aft wall on a first side of the sleeve. Similarly, the sleeve includes a second side wall coupled to the forward wall, the intermediate wall, and the aft wall on a second side of the sleeve. In this respect, the forward wall, the intermediate wall, the first side wall, and the second side wall collectively define a forward passage through which the shank body extends. For example, the forward wall of the sleeve may be positioned and held between the shank body and the shin. Furthermore, the intermediate wall, the aft wall, the first side wall, and the second side wall collectively define an aft passage. In some embodiments, a portion (e.g., an outlet portion) of a dry agricultural product dispensing device may be partially positioned within the aft passage.

The sleeve improves the operation of the ground-engaging shank and the agricultural implement on which the ground-engaging shank is installed. More specifically, as indicated above, the soil flowing past the shank body during operation of the agricultural implement can cause significant friction. Such friction, in turn, accelerates the wear of the shank body, thereby necessitating frequent (and costly) replacement. However, with the disclosed shank assembly, the shank body is positioned or otherwise encased within the forward passage of the sleeve. In this respect, the sleeve, which can be made of a harder material and costs less to replace, protects the shank body from contact with the soil flowing past the shank assembly. As such, the sleeve extends the life of the shank body, thereby reducing the frequency with which it is necessary to replace the shank body (and, thus, the associated cost of operating and maintaining the agricultural implement).

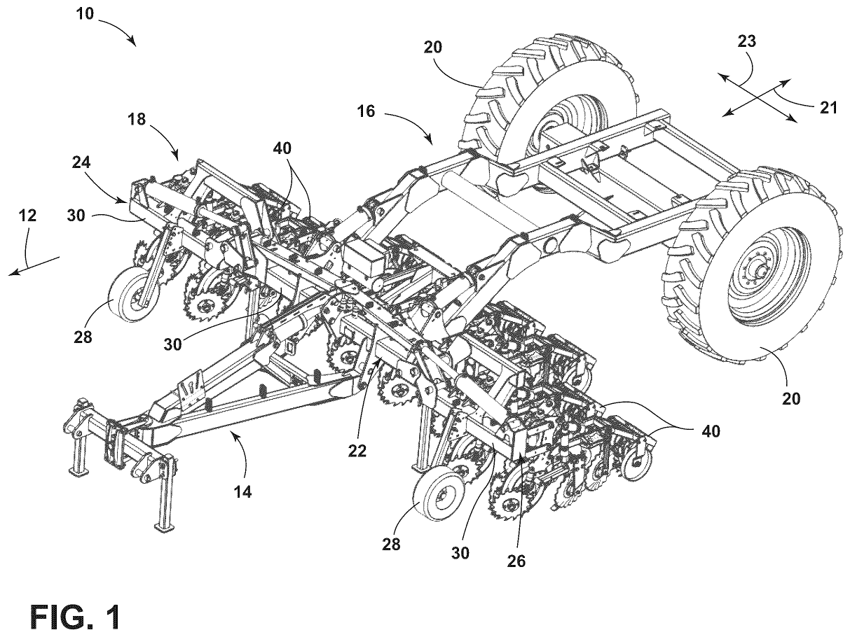

Referring now to the drawings, FIG. 1 illustrates a perspective view of one embodiment of an agricultural implement 10 in accordance with aspects of the present subject matter. In general, the agricultural implement 10 may be configured to be towed across a field in a forward direction of travel (e.g., as indicated by arrow 12 in FIG. 1) by a work vehicle (e.g., an agricultural tractor). As shown, the agricultural implement 10 is configured as a strip tillage implement. However, in other embodiments, the agricultural implement 10 may be configured as any other suitable type of implement, such as a seed-planting implement, a fertilizer-dispensing implement, and/or the like.

As shown in FIG. 1, the agricultural implement 10 includes a towbar assembly 14, a chassis assembly 16, and a toolbar assembly 18. In general, the towbar assembly 14 may be configured to allow the implement 10 to be coupled to a tow vehicle (e.g., a tractor) for towing the agricultural implement 10 along a field during the performance of a strip-tillage operation. For instance, the towbar assembly 14 may incorporate a hitch or other suitable coupling for connecting the agricultural implement 10 to a tow vehicle. In one embodiment, the chassis assembly 16 may be configured to support one or more storage tanks (not shown). For instance, the storage tank(s) may correspond to a fertilizer tank or any other suitable type of storage tank configured to store an agricultural material. Additionally, the chassis assembly 16 may be coupled to one or more pairs of chassis support wheels 20. For example, as shown in FIG. 1, a pair of support wheels 20 are coupled to the aft end of the chassis assembly 16 to support the implement 10 relative to the ground.

In the illustrated embodiment, the chassis assembly 16 is positioned at the aft end of the implement 10 such that the toolbar assembly 18 is disposed between the towbar assembly 14 and the chassis assembly 16 along a longitudinal direction of the implement 10 (as indicated by arrow 21 in FIG. 1), with the longitudinal direction 21 extending generally parallel to the direction of travel 12. For instance, as shown in FIG. 1, toolbar assembly 18 is pivotably coupled at its forward end to the towbar assembly 14 and at its aft end to the chassis assembly 16. Alternatively, the chassis assembly 16 may be positioned between the towbar assembly 14 and the toolbar assembly 18 in the longitudinal direction 21 of the implement 10 such that the toolbar assembly 18 is disposed at the aft end of the implement 10. In such an embodiment, the forward end of the toolbar assembly 18 may be coupled to the aft end of the chassis assembly 16 (e.g., via connecting frame).

In several embodiments, the toolbar assembly 18 may be configured as a winged toolbar assembly. Specifically, as shown in FIG. 1, the toolbar assembly 18 includes a central toolbar section 22 and one or more wing toolbar sections coupled to and extending laterally (e.g., in a lateral direction 23 that is generally perpendicular to the longitudinal direction 21) from the central toolbar section 22 (e.g., a first wing toolbar section 24 coupled to one lateral end of the central toolbar section 22 and a second wing toolbar section 26 coupled to the opposed lateral end of the central toolbar section 22). Additionally, as shown in FIG. 1, a wing support wheel 28 may be coupled to each wing toolbar section 24, 26 (e.g., at the front of each wing toolbar section 24, 26) to support the toolbar section 24, 26 relative to the ground. In one embodiment, the wing support wheels 28 may function as gauge wheels for the wing toolbar sections 24, 26.

In general, each of the various toolbar sections 22, 24, 26 may include one or more laterally extending toolbars 30 configured to support a plurality of row units 40. For instance, in one embodiment, each row unit 40 may be coupled to its respective toolbar 30 via a four-bar linkage. In the illustrated embodiment, the row units 40 are configured as strip tillage units. As such, each row unit 40 may include one or more ground-engaging tools for working the soil in narrow strips extending in the forward direction of travel 12 of implement 10. For instance, in one embodiment, each row unit 40 may include one or more row cleaner discs, coulter discs, shank or knife assemblies, finishing or conditioning units, and/or the like for tilling narrow strips of soil during the performance of a strip tillage operation. Additionally, each row unit 40 may also incorporate one or more components for supplying agricultural materials to the soil, such as injectors or tubes for directing agricultural material (e.g., fertilizer) supplied from a storage tank supported on the chassis assembly 16 (or from any other source) into the worked soil.

It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

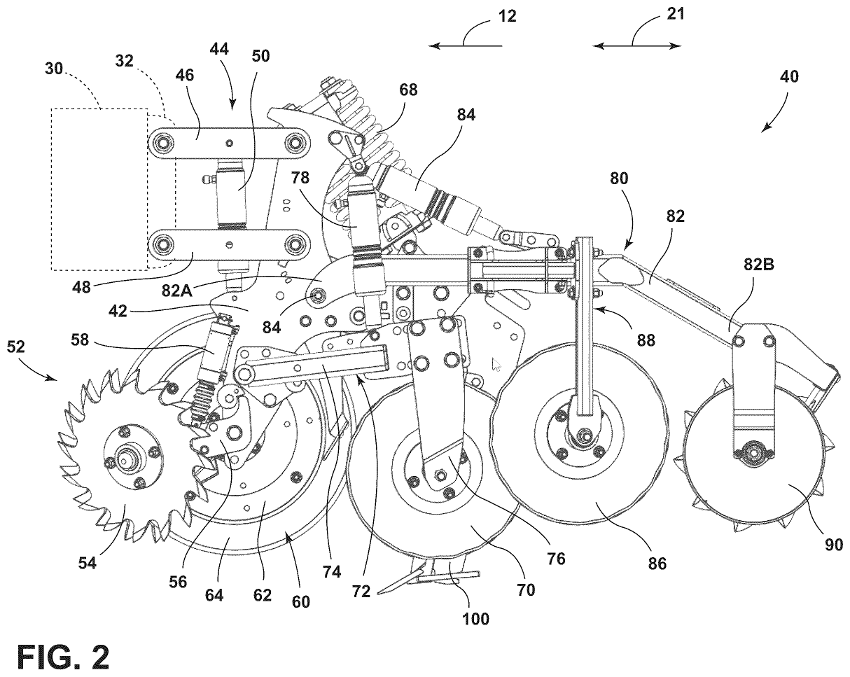

Referring now to FIG. 2, a side view of one embodiment of a row unit 40 suitable for use with the implement 10 shown in FIG. 1 is illustrated in accordance with aspects of the present subject matter. As shown, the row unit 40 includes a main frame or backbone 42 (referred to herein as simply the “frame 42” of the row unit 40) configured to be adjustably coupled to a toolbar (e.g., toolbar 30 and associated mounting bracket(s) 32) of the implement 10 via a linkage assembly 44. For example, in one embodiment, the frame 42 may be coupled to the toolbar 30 via a four-bar linkage including one or more pairs of first and second linkages 46, 48, with one end of each linkage 46, 48 being pivotably coupled to the frame 42 and the opposed end of each linkage 46, 48 being pivotably coupled to the toolbar 30 (e.g., via the associated mounting bracket(s) 32). However, in alternative embodiments, the frame 42 of the row unit 40 may be coupled to the toolbar 30 in any other suitable manner. Additionally, the row unit 40 may include one or more downforce actuators 50 provided in operative association with the linkage assembly 44 for applying a downforce to the row unit 40. In one embodiment, the downforce actuators 50 may be passive actuators, such as air shocks or springs. Alternatively, the downforce actuators 50 may be actively controlled actuators, such as pneumatic or hydraulic cylinders.

Moreover, as shown in FIG. 2, the row unit 40 may include a plurality of ground-engaging tools coupled to and/or supported by the frame 42. For instance, in several embodiments, the row unit 40 may include a row cleaner assembly or “row cleaner” 52 positioned at the forward end of the row unit 40 relative to the forward direction of travel 12. In general, the row cleaner 52 may be configured to break up and/or sweep away residue, dirt clods, and/or the like from the travel path of the various components positioned downstream or aft of the row cleaner 52. In one embodiment, the row cleaner 52 may include a pair of row cleaner discs 54 (only one of which is shown in FIG. 2), with each disc 54 being pivotably coupled to the main frame via a respective row cleaner arm 56. In general, the row cleaner discs 54 may be toothed or spiked, such as by including a plurality of fingers or teeth extending radially outwardly from a central disc hub. As such, the discs 54 may be configured to roll relative to the soil as the implement 10 is moved across the field such that the teeth break up and/or sweep away residue and dirt clods. Additionally, as shown in FIG. 2, the row unit 40 may also include one or more row cleaner actuators 58 provided in association with the row cleaner 52. For instance, in the illustrated embodiment, the row unit 40 includes a pair of row cleaner actuators 58 (only one of which is shown in FIG. 2) configured to provide a downward biasing force against the row cleaner 52, with each row cleaner actuator 58 being coupled between the main frame 42 and a respective row cleaner arm 56. In one embodiment, the row cleaner actuators 58 may be passive actuators, such as air shocks or springs. Alternatively, the row cleaner actuators 58 may be actively controlled actuators, such as pneumatic or hydraulic cylinders.

Moreover, as shown in FIG. 2, the row unit 40 may also include a center coulter 60 positioned immediately aft of the row cleaner 52 relative to the forward direction of travel 12 of the implement 10. The center coulter 60 may generally be aligned with a longitudinal centerline of the row unit 40 such that the coulter 60 is positioned in the center of the row unit 40 relative to the lateral direction 23 of the implement 10 (i.e., the direction into and out of the page in FIG. 2). In one embodiment, the center coulter 60 may include a central hub 62 coupled to the main frame 42 for rotation relative thereto and a peripheral blade 64 extending radially outwardly from the hub 62 around its outer perimeter. The center coulter 60 may generally be configured to cut a slot or slit within the field along the center of the “row” being processed or formed by the row unit 40. Additionally, the center coulter 60 may also function together with the row cleaner 52 to ensure that residue and other trash is swept or moved laterally away from the travel path of further downstream components of the row unit 40. For instance, in one embodiment, as the row cleaner discs 54 rotate relative to the ground, the discs 54 may be configured to trap residue against the surface of the field. The blade 64 of center coulter 60 may then slice or cut through the trapped residue extending between the pair of row cleaner discs 54, thereby allowing the cut residue to be swept away from the longitudinal centerline of the row unit 40 via the action of the row cleaner discs 54.

Referring still to FIG. 2, in several embodiments, the row unit 40 may include a shank assembly 100 mounted to the main frame 42 at a location aft of the central hub 62 relative to the forward direction of travel 12 of the implement 10. In one embodiment, the shank assembly 100 may generally be aligned with the center coulter 60 in the lateral direction 23 of the implement 10. The shank assembly 100 may be configured to break up the soil along the lateral width of the row being formed by the row unit 40 at a location aft of the center coulter 60. For example, the shank assembly 100 may be aligned with the blade 64 of the center coulter 60 such that the shank assembly 100 travels through and breaks open the slit or slot cut into the soil via the center coulter 60. As shown in FIG. 2, the row unit 40 may also include one or more shank actuators 68 provided in association with the shank assembly 100 for providing a downward biasing force thereto. For instance, in the illustrated embodiment, the row unit 40 includes a pair of shank actuators 68, with each shank actuator 68 being coupled between the main frame 42 and the shank assembly 100. In one embodiment, the shank actuators 68 may be passive actuators, such as air shocks or springs. Alternatively, the shank actuators 68 may be actively controlled actuators, such as pneumatic or hydraulic cylinders.

Additionally, in several embodiments, the row unit 40 may include a forward or first pair of side coulter discs 70 (only one of which is shown in FIG. 2) positioned immediately aft of the center coulter 60 relative to the forward direction of travel 12, with each first side coulter disc 70 being disposed along either side of the shank assembly 100 such that the discs 70 are spaced apart from the shank assembly 100 in the lateral direction 23 of the implement 10. In one embodiment, each first side coulter disc 70 is pivotably coupled to the main frame 42 via a first side coulter mount assembly 72. For instance, as shown in FIG. 2, the side coulter arm assembly 72 includes a mounting arm 74 and a support arm 76, with the mounting arm 74 being pivotably coupled to the main frame 42 at one end and being coupled to the support arm 76 at the other end. The support arm 76 may, in turn, be coupled between the mounting arm 74 and its respective first side coulter disc 70 in a manner that allows the coulter disc 70 to rotate relative to the support arm 76 as the row unit 40 is being moved across the field. As shown in FIG. 2, the row unit 40 may also include one or more side coulter actuators 78 provided in association with the side coulters 78 for applying a downward biasing force thereto. For instance, in the illustrated embodiment, the row unit 40 includes a pair of side coulter actuators 78 (only one of which is shown in FIG. 2), with each side coulter actuator 78 being coupled between the main frame 42 and a respective coulter arm assembly 72. In one embodiment, the side coulter actuators 78 may be passive actuators, such as air shocks or springs. Alternatively, the side coulter actuators 78 may be actively controlled actuators, such as pneumatic or hydraulic cylinders.

In several embodiments, the side coulter discs 70 may function together with the shank assembly 100 to break out the soil along the width of the strip being worked or formed by the row unit 40. For instance, the side coulter discs 70 may be configured to “score” the soil to provide a pre-fracture at the desired width of the strip being formed. As an example, the side coulter discs 70 may be configured to run at a relatively shallow depth (e.g., 1-2 inches) to create scores or fracture lines within the soil along the lateral edges of the row being formed. The shank assembly 100 may, in turn, be configured to break up the hard soil across the lateral width extending between the fracture lines created by the side coulter discs 70.

Moreover, in several embodiments, the row unit 40 may include an aft frame assembly 80 coupled to the main frame 42 for supporting additional ground-engaging tools of the row unit 40. As shown in FIG. 2, the aft frame assembly 80 may include a pair of aft frame members 82 (only one of which is shown in FIG. 2) extending between a forward end 82A and an aft end 82B, with the forward end 82A of each frame member 82 being pivotably coupled to the main frame 42 at a forward pivot point. Each frame member 82 extends rearwardly from the pivot point relative to the forward direction of travel 12 to its aft end 82B positioned adjacent to the aft end of the row unit 40. Additionally, in one embodiment, the row unit 40 may include one or more aft frame actuators 84 provided in association with the aft frame assembly 80 for providing a downward biasing force to the frame assembly 80 (and any ground-engaging tools supported thereby). For instance, in the illustrated embodiment, the row unit 40 includes a pair of aft frame actuators 84 (only one of which is shown in FIG. 2), with each aft frame actuator 84 being coupled between the main frame 42 and a respective aft frame member 82 of the aft frame assembly 80. In one embodiment, the aft frame actuators 84 may be passive actuators, such as air shocks or springs. Alternatively, the aft frame actuators 84 may be actively controlled actuators, such as pneumatic or hydraulic cylinders.

As shown in FIG. 2, in several embodiments, the aft frame assembly 80 may be configured to support an aft or second pair of side coulter discs 86 positioned aft or rearward of the forward or first pair of side coulter discs 70 (and aft of the shank assembly 100) relative to the forward direction of travel 12, with each second side coulter disc 86 being disposed along either side of the longitudinal centerline of the row unit 40 such that the discs 86 are spaced apart from the centerline in the lateral direction 23 of the implement 10. In one embodiment, the second side coulter discs 86 may be configured to catch or block the soil coming off of the first side coulter discs 70 and shank assembly 100 and redirect such soil back towards the center of the row being formed. As a result of redirecting the thrown soil back towards the center of the row, the aft or second side coulter discs 86 may function as “berm builders” to create a berm of soil along the centerline of the row unit 40. In such instance, the second side coulter discs 86 may be set to run at a relatively shallow depth (e.g., 1 inch or less) so that the coulter discs 86 can catch the soil without effectively tilling the soil. Alternatively, the second side coulter discs 86 may be set at a less shallow depth to allow the coulter discs 86 to perform shallow tillage (e.g., to widen the strip of worked soil beyond what the first side coulter discs 70 achieved) while still performing the function of directing soil into the right lateral shape to build a proper berm across the width of the row. In one embodiment, each second side coulter disc 86 is coupled to the aft frame assembly 80 via a second side coulter mount assembly 88. In one embodiment, the side coulter mount assembly 88 may be configured to allow the positioning of the second side coulter discs 86 to be adjusted relative to the other tools of the row unit 40, thereby allowing the coulter discs 86 to be set properly for performing their soil-catching function.

Moreover, as shown in FIG. 2, the row unit 40 may also include a finishing tool positioned at the aft end of the row unit 40. Specifically, in the illustrated embodiment, the row unit 40 includes a strip conditioner 90 coupled to the aft end 82B of the aft frame assembly 80. In general, the strip conditioner 90 may have any suitable configuration that allows it to perform its function as a finishing tool. In one embodiment, the strip conditioner 90 may be configured as a spider conditioner that functions to reduce the size of soil clods across the width of the row being formed. In other embodiments, a conditioning reel or basket may be used as the finishing tool.

It should be appreciated that the configuration of the row unit 40 described above and shown in FIG. 2 is provided only to place the present subject matter in an exemplary field of use. Thus, it should be appreciated that the present subject matter may be readily adaptable to any manner of row unit configuration.

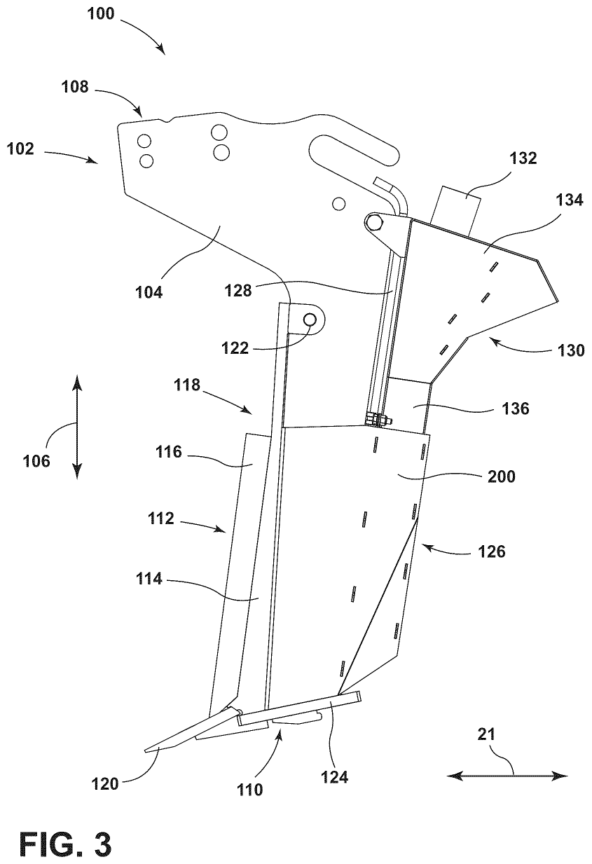

FIG. 3 illustrates a side view of one embodiment of a shank assembly 100 suitable for use with the agricultural implement 10 shown in FIG. 1 and the row unit 40 shown in FIG. 2 is illustrated in accordance with aspects of the present subject matter. As shown, the shank assembly 100 includes a ground-engaging shank 102 configured to be moved through the soil as the agricultural implement 10 travels across the field (e.g., to perform a strip tillage operation thereon). In this respect, the ground-engaging shank 102 in combination with other components of the row unit 40 (e.g., the forward pair of side coulter discs 70) may break up the soil along the lateral width of a row or strip being tilled by the row unit 40 on which the ground-engaging shank 102 is mounted.

In several embodiments, the ground-engaging shank 102 includes a shank body 104. Specifically, the shank body 104 may extend in a vertical direction (e.g., indicated by arrow 106 in FIG. 3) from a top end 108 of the shank body 104 to a bottom end 110 of the shank body 104. The top end 108 of the shank body 104, in turn, may be coupled to the frame 42 of the row unit 40. In this respect, the shank body 104 extends downward in the vertical direction 106 such that the bottom end 110 is positioned at a suitable location to engage the soil within the field. As such, the shank body 104 forms the main structural component of the ground-engaging shank 102.

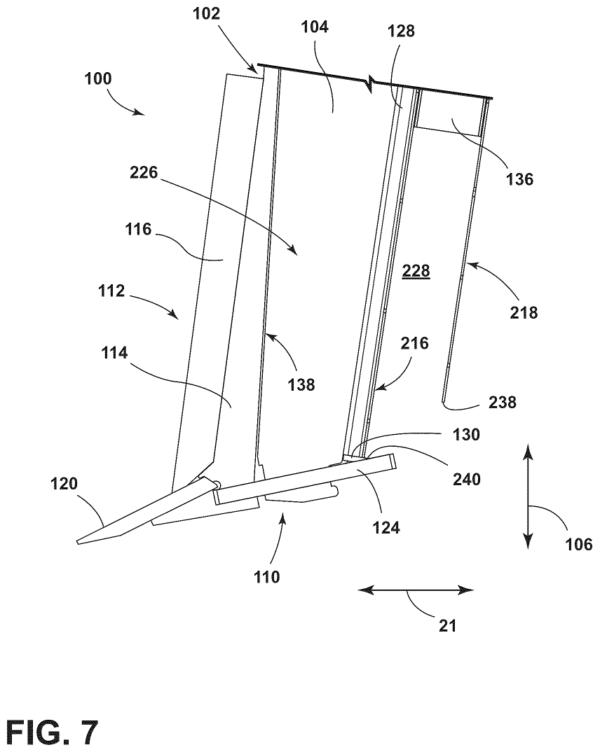

Furthermore, in some embodiments, the ground-engaging shank 102 may include a shin 112 coupled to and positioned forward of the shank body 104 in the longitudinal direction 21 (i.e., relative to the direction of travel 12). That is, the shin 112 may be mounted or otherwise positioned on a forward side 118 of the shank body 104. In general, as the ground-engaging shank 102 is moved through the soil, such soil contacts and flows past the shin 112, thereby protecting the forward side 118 of the shank body 104. As such, the shin 112 may have any suitable configuration that allows the shin 112 to function as described herein. For example, in the illustrated embodiment, the shin 112 includes a base member 114 coupled to the shank body 104 at a mounting location 122, a leading edge portion 116 positioned forward of the base member 114 to engage the soil, and a tip 120 configured to penetrate into or pierce the soil surface. As will be described below, a gap 138 (FIG. 7) is defined between the shin 112 (and, more specifically, the base member 114 of the shin 112) and the shank body 104 in the longitudinal direction 21.

Additionally, in some embodiments, the ground-engaging shank 102 may include a shoe 124. Specifically, the shoe 124 may be coupled to the bottom end of the shin 112, such as to the base member 114. In this respect, the top end of the shin 112 may be coupled to the shank body 104 at the top end 108 of the shank body 104, while the bottom end of the shin 112 may be coupled to the shoe 124. As such, the shoe 124 may extend rearward in the longitudinal direction 21 and couple to the aft end of shank body 104, such as via a slot defined by the shank body 104. Thus, the shoe 124 may assist in securing the shin 112 to the shank body 104.

Moreover, the shank assembly 100 includes a sleeve 200. In general, the sleeve 200 is configured to protect the shank body 104 from contact with the soil flowing past the shank assembly 100 during operation. As will be described below, the sleeve 200 slides over and encases or encapsulates the shank body 104. For example, a portion of the sleeve 200 may be positioned within the gap 138 (FIG. 7) defined between the shin 112 and the shank body 104 in the longitudinal direction 21. In this respect, after flowing past the shin 112, the soil then flows past the sleeve 200 such that the sleeve 200 protects the lateral sides of the shank body 104 from wear caused by the flowing soil.

In addition, the shank assembly 100 may include one or more components positioned on its aft side 126 for delivering agricultural products to the soil aft of the ground-engaging shank 102. Specifically, in several embodiments, the shank assembly 100 may include a tube 128 configured to convey an agricultural fluid, such as anhydrous ammonia, toward the soil aft of the ground-engaging shank 102 in the longitudinal direction 21. As will be described below, the tube 128 may extend through the sleeve 200 in addition to the shank body 104.

Furthermore, in some embodiments, the shank assembly 100 includes a dry agricultural product dispensing device 130. In general, the dry agricultural product dispensing device 130 is configured to dispense a dry agricultural product (e.g., granular fertilizer fluidized in a stream of the pressurized air) into the soil aft of the ground-engaging shank 102 in the longitudinal direction 21. For example, in the illustrated embodiment, the dry agricultural product dispensing device 130 includes an inlet portion 132, a transition portion 134, and an outlet portion 136. In such an embodiment, the inlet portion 132 may be coupled to a dry agricultural product supply conduit, such as a hose (not shown) supplying granular fertilizer fluidized in a stream of the pressurized air from a storage tank (not shown). Moreover, the transition portion 134 directs the dry agricultural product from the inlet portion 132 (e.g., which may be circular) to the outlet portion 136 (e.g., which may be rectangular). As will be described below, the outlet portion 136 may be partially positioned within the sleeve 200.

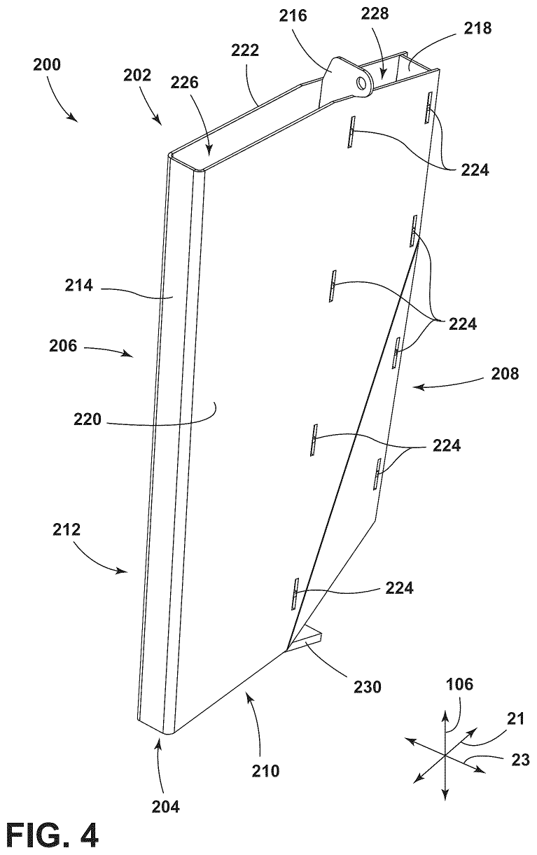

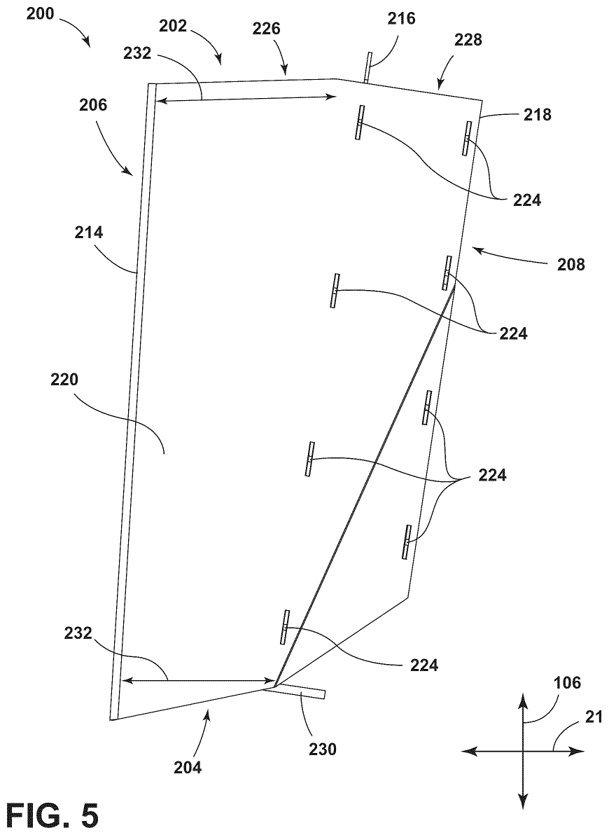

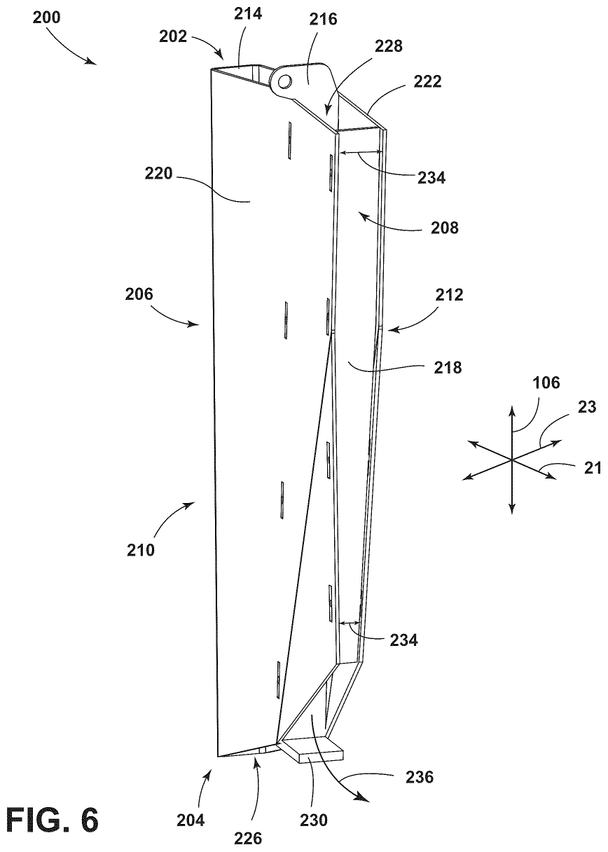

FIGS. 4-6 illustrate differing views of the sleeve 200. Specifically, FIG. 4 illustrates a front perspective view of the sleeve 200. Furthermore, FIG. 5 illustrates a side view of the sleeve 200. In addition, FIG. 6 illustrates a rear perspective view of the sleeve 200. As shown, the sleeve 200 extends in the vertical direction 106 from a top end 202 of the sleeve 200 to a bottom end 204 of the sleeve 200. Additionally, the sleeve 200 extends in the longitudinal direction 21 from a forward end 206 of the sleeve 200 to an aft end 208 of the sleeve 200. Moreover, the sleeve 200 extends in the lateral direction 23 from a first side 210 of the sleeve 200 to a second side 212 of the sleeve 200.

In general, the sleeve 200 includes a plurality of walls forming the structure of the sleeve 200. More specifically, the sleeve 200 includes a forward wall 214 extending in the vertical direction 106 from the top end 202 to the bottom end 204 and in the lateral direction 23 from the first side 210 to the second side 212. Furthermore, the sleeve 200 includes an intermediate wall 216 extending in the vertical direction 106 from the top end 202 to the bottom end 204 and in the lateral direction 23 from the first side 210 to the second side 212. Moreover, the intermediate wall 216 is positioned aft of and spaced apart from the forward wall 214 in the longitudinal direction 21. Additionally, the sleeve 200 includes an aft wall 218 extending in the vertical direction 106 from the top end 202 to the bottom end 204 and in the lateral direction 23 from the first side 210 to the second side 212. Moreover, the aft wall 218 is positioned aft of and spaced apart from the intermediate wall 216 in the longitudinal direction 21. In addition, the sleeve 200 includes a first side wall 220 extending in the vertical direction 106 from the top end 202 to the bottom end 204 and in the longitudinal direction 21 from the forward end 206 to the aft end 208 such that the first side wall 220 is coupled to the forward wall 214, the intermediate wall 216, and the aft wall 218 on the first side 210 (e.g., via the illustrated spot welds 224). Furthermore, the sleeve 200 includes a second side wall 222 extending in the vertical direction 106 from the top end 202 to the bottom end 204 and in the longitudinal direction 21 from the forward end 206 to the aft end 208 such that the second side wall 222 is coupled to the forward wall 214, the intermediate wall 216, and the aft wall 218 on the second side 212 (e.g., via spot welds (not shown)).

In several embodiments, the sleeve 200 defines a forward passage 226 configured to receive the ground-engaging shank 102. More specifically, the forward wall 214, the intermediate wall 216, the first side wall 220, and the second side wall 222 collectively define the forward passage 226. In this respect, the forward passage 226 extends all of the way through the sleeve 200 such that the forward passage 226 is open on both the top end 202 and the bottom end 204 of the sleeve 200. Moreover, as particularly shown in FIG. 5, in some embodiments, a length (e.g., as indicated by arrows 232 in FIG. 5) of the forward passage 226 in the longitudinal direction 21 decreases as the forward passage 226 extends in the vertical direction 106 from the top end 202 to the bottom end 204. That is, the forward passage 226 tapers in the longitudinal direction 21 downward such that the length 232 of the forward passage 226 in the longitudinal direction 21 at the top end 202 of the sleeve 200 is greater than the length 232 of the forward passage 226 in the longitudinal direction 21 at the bottom end 204 of the sleeve 200. As will be described below, such tapering assists with the installation of the sleeve 200 onto the ground-engaging shank 102.

Additionally, in several embodiments, the sleeve 200 defines an aft passage 228 configured to partially receive the dry agricultural product dispensing device 130. In this respect, the dispensed dry agricultural product (e.g., as indicated by arrow 236 in FIG. 6) may fall through the aft passage 228 and onto the soil aft of the ground-engaging shank 102 in the longitudinal direction 21 (i.e., relative to the direction of travel 12). For example, as will be described below, in some embodiment, a tab 230 coupled to the bottom of the intermediate wall 216 may disperse or splatter the dry agricultural product 236 over a wider lateral area of the soil. More specifically, the intermediate wall 216, the aft wall 218, the first side wall 220, and the second side wall 222 collectively define the aft passage 228. As such, the aft passage 228 extends all of the way through the sleeve 200 such that the aft passage 228 is open on both the top end 202 and the bottom end 204 of the sleeve 200. Furthermore, as particularly shown in FIG. 6, in some embodiments, a width (e.g., as indicated by arrows 234 in FIG. 6) of the aft passage 228 in the lateral direction 23 decreases as the aft passage 228 extends in the vertical direction 106 from the top end 202 to the bottom end 204. That is, the aft passage 228 tapers in the lateral direction 23 downward such that the width 234 of the aft passage 228 in the lateral direction 23 at the top end 202 of the sleeve 200 is greater than the width 234 of the aft passage 228 in the lateral direction 23 at the bottom end 204 of the sleeve 200.

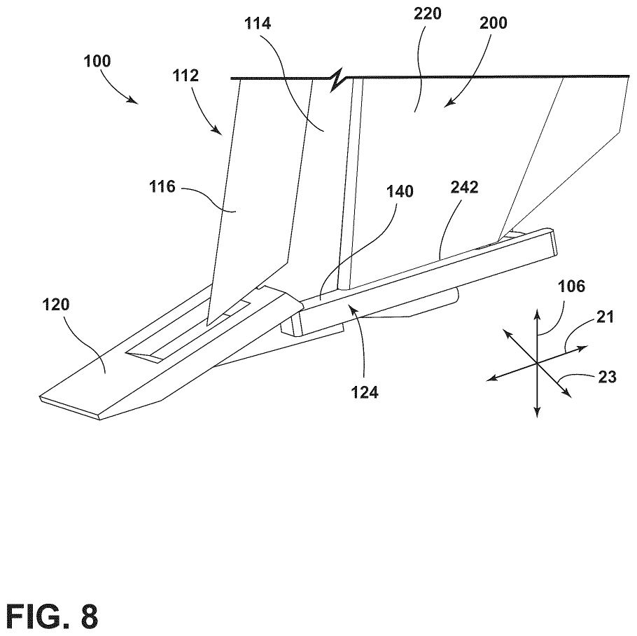

FIG. 7 illustrates a partial side view of the shank assembly 100, with the forward wall 214, the first side wall 220, and the second side wall 222 of the sleeve 200 removed for purposes of clarity. As mentioned above, the shank body 104 is received into the forward passage 226 of the sleeve 200, thereby protecting the lateral sides of the shank body 104 from the flowing soil and the associated wear. More specifically, in several embodiments, the bottom end 110 of the shank body 104 is inserted into the forward passage 226 at the top end 202 of the sleeve 200. The sleeve 200 is then slid upward in the vertical direction 106 relative to the shank body 104 until the tapering of the forward passage 226 prevents further upward movement. The shin 112 is coupled to the shank body 104 at the mounting location 122 a pivoted toward the forward side 118 of the shank body 104 such that the shin 112 contacts the forward wall 214 of the sleeve 200. The shoe 124, which is coupled to the bottom end of the shin 112, is secured to the aft end of the shank body 104 (e.g., the aft side of the shoe 124 may be received in a slot on the aft side of the shank body 104). Thus, the forward wall 214 of the sleeve 200 is positioned within the gap 138 between the shin 112 and the shank body 104 and secured between the shin 112 and the shank body 104 in the longitudinal direction 21. Moreover, as shown in FIG. 8, a bottom edge 242 of the first side wall 220 and the second side wall 222 contacts or otherwise rests on a top surface 140 of the shoe 124, such that the shoe 124 protects the bottom end 204 of the sleeve 200 from wear and/or damage.

Furthermore, as shown in FIG. 7, the tube 128 extends through the forward passage 226 of the sleeve 200 from the top end 202 of the sleeve 200 through the bottom end 204 of the sleeve 200. Specifically, the tube 128 is positioned aft of the shank body 104 and forward of the intermediate wall 216 in the longitudinal direction 21 (i.e., relative to the direction of travel 12). Thus, the tube 128 effectively forms an additional passage through the agricultural fluid (e.g., anhydrous ammonia) flows that is positioned within the forward passage 226 and isolated from the forward and aft passages 226, 228. As will be described below, the tube 128 is coupled to the intermediate wall 216 such that the tube 128 is spaced apart from the intermediate wall 216 in the longitudinal direction 21.

Additionally, as shown in FIG. 7, the outlet portion 136 of the dry agricultural product dispensing device 130 is partially received within the aft passage 228. That is, the bottom end of the outlet portion 136 of the dry agricultural product dispensing device 130 is positioned within the top portion of the aft passage 228. In this respect, the dry agricultural product dispensed by the dry agricultural product dispensing device 130 falls through the aft passage 228 and onto the tab 230 for eventual delivery to a portion of the soil aft of the ground-engaging shank 102. Moreover, in one embodiment, a bottom edge 238 of the aft wall 218 is positioned above a bottom edge 240 of the intermediate wall 216 in the vertical direction 106. This, in turn, provides relief at the bottom, aft end of the sleeve 200 to prevent contact between the soil and the bottom aft end of the sleeve 200.

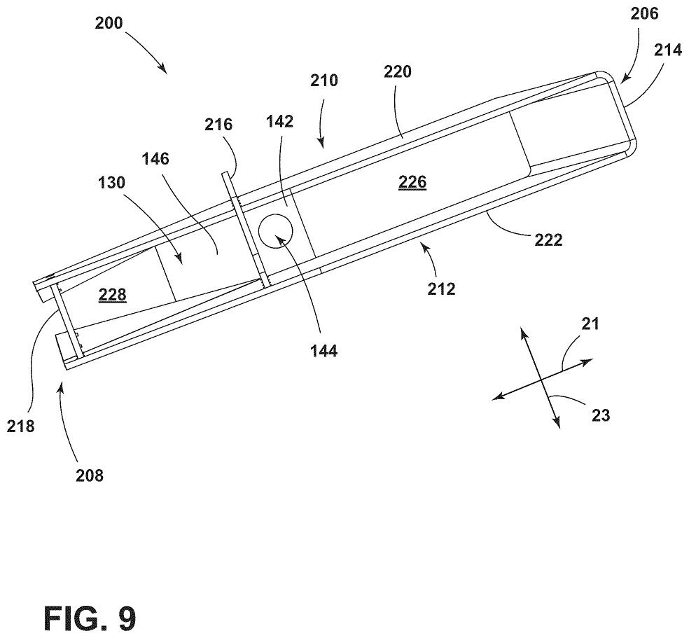

FIG. 9 illustrates a top perspective view of the sleeve 200 in accordance with aspects of the present subject matter. As mentioned above, in several embodiments, the sleeve 200 includes the tab 230 positioned at the bottom end 204 of the sleeve 200. More specifically, the tab 230 (e.g., its top surface) is coupled (e.g., welded) to the bottom edge 240 of the intermediate wall 216 such that the tab 230 is partially positioned below the forward passage 226 and partially positioned below the aft passage 228. For example, in one embodiment, the tab 230 may be perpendicular to the intermediate wall 216. In this respect, the tab 230 includes a first portion 142 extending forward of the intermediate wall 216 in the longitudinal direction 21 (i.e., relative to the direction of travel 12) and a second portion 146 extending aft of the intermediate wall 216 in the longitudinal direction 21 (i.e., relative to the direction of travel 12). The first portion 142 of the tab 230 defines a hole 144 through which the tube 128 extends. Moreover, the second portion 146 of the tab 230 is configured to disperse or otherwise splatter the dry agricultural product falling through the aft passage 228, such as in the lateral direction 23. That is, the dry agricultural product that falls on the tab 230 bounces off laterally.

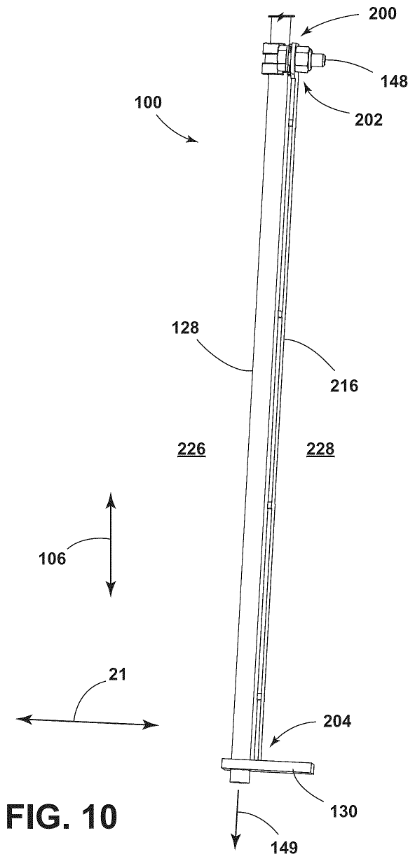

Furthermore, FIG. 10 illustrates a side view of the shank assembly 100, with all of its components except for the tube 128, the intermediate wall 216 of the sleeve 200, the tab 230, and an isolator 148 removed for clarity. As mentioned above, the tube 128 is positioned within the forward passage 226 and extends from the top end 202 of the sleeve 200 to the bottom end 204 of the sleeve 200. Moreover, the tube 128 is coupled to and spaced apart from the intermediate wall 216. Specifically, in several embodiments, the tube 128 is coupled to the intermediate wall 216 at the top end 202 of the sleeve 200 via the isolator 148 (e.g., a P-bracket). Conversely, the tube 128 extends through the hole 144 defined the tab 230 at the bottom end 204 of the sleeve 200. In one embodiment, the tube 128 is not directly secured (e.g., welded) to the tab 230. Rather, the tube 128 may simply float relative to the hole 144. Additionally, as indicated above, the fastener 148 and the hole 144 may generally position the tube 128 such that the tube 128 is spaced apart from the intermediate wall 216 in the longitudinal direction 21. This spacing, in turn, prevents the agricultural fluid (indicated by arrow 149 in FIG. 10) flowing through the tube 128 and being discharged into the soil from sufficiently cooling the sleeve 200 such that soil or other moisture containing field materials adhere to and freeze on the shank assembly 100.

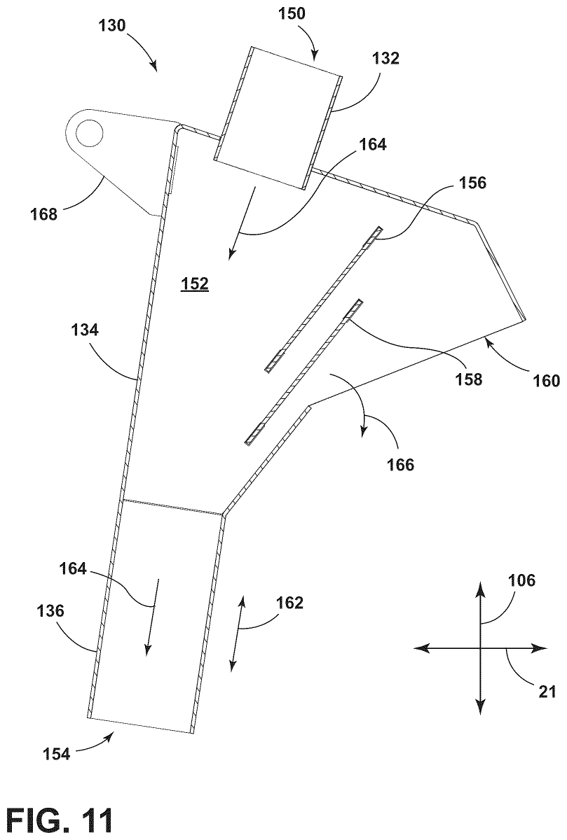

Additionally, FIG. 11 illustrates a partial sectional side view of the dry agricultural product dispensing device 130 in accordance with aspects of the present subject matter. As mentioned above, in some embodiments, the dry agricultural product dispensing device 130 may include the inlet portion 132, the transition portion 134, and the outlet portion 136. In such embodiments, the inlet portion 132 may define an inlet port 150 that may receive the dry agricultural product (e.g., as indicated by arrows 164 in FIG. 11), such as from a dry agricultural product supply conduit (not shown). Moreover, the transition portion 134 may define a transition cavity 152 that receives the dry agricultural product 164 from the inlet port 150 and conveys the dry agricultural product 164 to an outlet port 154 defined by the outlet section 136. For example, in one embodiment, the transition section 134 may include one or more baffles, such as the illustrated baffles 156, 158, positioned within the transition cavity 152. The baffles 156, 158, in turn, direct the dry agricultural product from the inlet port 150 (e.g., which may have a circular cross-section) and into the outlet port 154 (e.g., which may have a rectangular cross-section) for eventual delivery to the aft passage of the sleeve 200.

Furthermore, the transition portion 134 may define an air release port 160 configured to exhaust the air (e.g., as indicated by arrow 166 in FIG. 11) used to convey fluidize or otherwise convey the dry agricultural product 164 to the soil from the shank assembly 100. Specifically, the air release port 160 may at least partially direct the air downward toward the surface of the field. Thus, should the outlet port 154 or the aft passage 228 become plugged, the dry agricultural product 164 may ejected from the air release port 160 downward to soil aft of the ground-engaging shank 102 and not all over the agricultural implement 10.

In addition, the outlet portion 136 may be configured to telescope relative to the shank body 104 or other have an adjustable length in the vertical direction 106 (e.g., as indicated by arrow 162 in FIG. 11). As such, the dry agricultural product dispensing device 130 may accommodate ground-engaging shanks 102 and/or sleeve 200 of varying sizes (e.g., varying lengths in the vertical direction 106).

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A shank assembly for an agricultural implement, the shank assembly comprising:
a ground-engaging shank including a shank body; and
a sleeve configured to protect the shank body, the sleeve including:
a forward wall;
an intermediate wall positioned aft of and spaced apart from the forward wall in a longitudinal direction;
an aft wall positioned aft of and spaced apart from the intermediate wall in the longitudinal direction;
a first side wall coupled to the forward wall, the intermediate wall, and the aft wall on a first side of the sleeve; and
a second side wall coupled to the forward wall, the intermediate wall, and the aft wall on a second side of the sleeve,
wherein:
the forward wall, the intermediate wall, the first side wall, and the second side wall collectively define a forward passage through which the shank body extends, and
the intermediate wall, the aft wall, the first side wall, and the second side wall collectively define an aft passage.

2. The shank assembly of claim 1, wherein the ground-engaging shank further includes a shin coupled to and positioned forward of the shank body in the longitudinal direction such that the forward wall is positioned between the shin and the shank body in the longitudinal direction.

3. The shank assembly of claim 2, wherein the ground-engaging shank further includes a shoe coupled to the shin and the shank body such that a bottom edge of the first side wall and a bottom edge of the second side wall contact a top surface of the shoe.

4. The shank assembly of claim 1, further comprising:
a tube positioned within the forward passage and coupled to the intermediate wall, the tube extending from a top end of the sleeve to a bottom end of the sleeve and being configured to convey an agricultural fluid toward soil aft of the ground-engaging shank in the longitudinal direction.

5. The shank assembly of claim 4, wherein the tube is spaced apart from the intermediate wall in the longitudinal direction.

6. The shank assembly of claim 5, wherein the sleeve further includes a tab coupled to a bottom edge of the intermediate wall, the tab defining a hole through which the tube extends.

7. The shank assembly of claim 1, further comprising:
a dry agricultural product dispensing device configured to dispense a dry agricultural product into the aft passage, the dry agricultural product dispensing device including an inlet portion, a transition portion coupled to the inlet portion, and an outlet portion coupled to the transition portion, the outlet portion being partially positioned within the aft passage.

8. The shank assembly of claim 7, wherein the outlet portion is configured to telescope relative to the shank body.

9. The shank assembly of claim 7, wherein the transition portion includes a baffle configured to direct the dry agricultural product from the inlet portion to the outlet portion.

10. The shank assembly of claim 9, wherein the transition portion defines an air release port configured to exhaust air at least partially downward toward a surface of a field.

11. The shank assembly of claim 7, wherein the sleeve further includes a tab coupled to a bottom edge of the intermediate wall, the tab including a first portion extending forward of the intermediate wall in the longitudinal direction and a second portion extending aft of the intermediate wall in the longitudinal direction, the second portion being configured to disperse dry agricultural product falls through the aft passage.

12. The shank assembly of claim 1, wherein a length of the forward passage in the longitudinal direction decreases as the forward passage extends in a vertical direction from a top end of the sleeve to a bottom end of the sleeve.

13. A sleeve for agricultural implement shanks, the sleeve comprising:
a forward wall extending in a lateral direction from a first side of the sleeve to a second side of the sleeve;
an intermediate wall extending in the lateral direction from the first side to the second side, the intermediate wall positioned aft of and spaced apart from the forward wall in a longitudinal direction extending perpendicular to the lateral direction;
an aft wall extending in the lateral direction from the first side to the second side, the aft wall positioned aft of and spaced apart from the intermediate wall in the longitudinal direction;
a first side wall extending in the longitudinal direction from a forward end of the sleeve to an aft end of the sleeve, the first side wall coupled to the forward wall, the intermediate wall, and the aft wall on the first side;
a second side wall extending in the longitudinal direction from the forward end to the aft end, the second side wall coupled to the forward wall, the intermediate wall, and the aft wall on the second side,
wherein:
the forward wall, the intermediate wall, the first side wall, and the second side wall collectively define a forward passage configured to receive a ground-engaging shank of an agricultural implement, and
the intermediate wall, the aft wall, the first side wall, and the second side wall collectively define an aft passage configured to partially receive a dry agricultural product dispensing device of the agricultural implement.

14. The sleeve of claim 13, further comprising:
a tube positioned within the forward passage and extending from a top end of the sleeve to a bottom end of the sleeve, the tube being configured to convey an agricultural fluid toward aft of the ground-engaging shank in the longitudinal direction.

15. The sleeve of claim 14, further comprising:
a tab coupled to a bottom edge of the intermediate wall, the tab including a first portion extending forward of the intermediate wall in the longitudinal direction, the first portion defining a hole through which the tube extends.

16. The sleeve of claim 15, wherein the tab includes a second portion extending aft of the intermediate wall in the longitudinal direction, the second portion being configured to disperse dry agricultural product being dispensed by the dry agricultural product dispensing device.

17. The sleeve of claim 14, wherein the tube is coupled to and spaced apart from the intermediate wall in the longitudinal direction.

18. The sleeve of claim 13, wherein a length of the forward passage in the longitudinal direction decreases as the forward passage extends in a vertical direction from a top end of the sleeve to a bottom end of the sleeve.

19. The sleeve of claim 13, wherein a width of the aft passage in the lateral direction decreases as the aft passage extends from a top end of the sleeve to a bottom end of the sleeve.

20. The sleeve of claim 13, wherein a bottom edge of the aft wall is positioned above a bottom edge of the intermediate wall in a vertical direction extending from a top end of the sleeve to a bottom end of the sleeve.
